(19) United States
(12) Patent Application Publication
(10) Pub. No.: US 2025/0379394 A1
(43) Pub. Date: Dec. 11, 2025

(54) Integrated High Voltage Isolation Cover

(71) Applicant: Amphenol Alden Products Company, Brockton, MA (US)

(72) Inventors: Richard Ellis Rothenberger, Inverness, FL (US); Ronald Ivan Frank, Sharon, MA (US)

(21) Appl. No.: 18/738,779

(22) Filed: Jun. 10, 2024

(51) Int. Cl. H01R 13/53; H01R 43/20

(52) U.S. Cl. CPC H01R 13/53; H01R 43/20

(57) ABSTRACT

A device may include a front body. A device may include a rear body. A device may include a first forward contact supported by the front body. A device may include a second forward contact supported by the front body a direct distance from the first forward contact. A device may include a dielectric barrier between the first forward contact and second forward contact that defines a creep path that is no less than 2 times greater than the direct distance.

### FIELD

The present disclosure relates to a systems, device, and methods of providing a high voltage connection system.

### BACKGROUND

High voltage systems with a plurality of contacts can experience arcing between the contacts if the voltage applied to the connector exceeds the breakdown voltage of the air or other material between the contacts. This can result in physically large connectors and/or manufacturing methods prone to mistakes.

### SUMMARY

In some aspects, the techniques described herein relate to an electrical connector including: a front body; a rear body; a first forward contact supported by the front body; a second forward contact supported by the front body a direct distance from the first forward contact; and a dielectric barrier between the first forward contact and second forward contact that defines a creep path that is no less than 4 times greater than the direct distance.

In some aspects, the techniques described herein relate to an electrical connection system, the system including: a first electrical connector; and a second electrical connector, wherein a connection dielectric barrier between the first electrical connector and second electrical connector defines a connection creep path that is no less than 2 times greater than a direct distance between contacts of the first electrical connector or the second electrical connector.

In some aspects, the techniques described herein relate to a method of manufacturing an electrical connector, the method including: inserting a forward contact into a front body; inserting a feed wire through an aperture of a rear body; connecting the feed wire to the forward contact; and coupling the rear body to the front body.

Other objects, advantages and salient features of the disclosure will become apparent from the following detailed description, which, taken in conjunction with the annexed drawings, discloses a preferred embodiment of the present disclosure. This summary is not intended to identify essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein: The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a perspective view of an embodiment of an electrical connection system including a first electrical connector and a second electrical connector, according to at least some embodiments of the present disclosure.

FIG. 2 is a side cross-sectional view of an embodiment of a first electrical connector, according to at least some embodiments of the present disclosure.

FIG. 3 is a side cross-sectional view of an embodiment of a second electrical connector, according to at least some embodiments of the present disclosure.

FIG. 4 is a side cross-sectional view of a system of a first electrical connector mated to a second electrical connector, according to at least some embodiments of the present disclosure.

FIG. 5 is a flowchart illustrating an embodiment of a method of manufacturing electrical connectors and connection systems according to the present disclosure, according to at least some embodiments of the present disclosure.

FIG. 6 illustrated an embodiment of a partially assembled electrical connector, according to at least some embodiments of the present disclosure.

### DETAILED DESCRIPTION

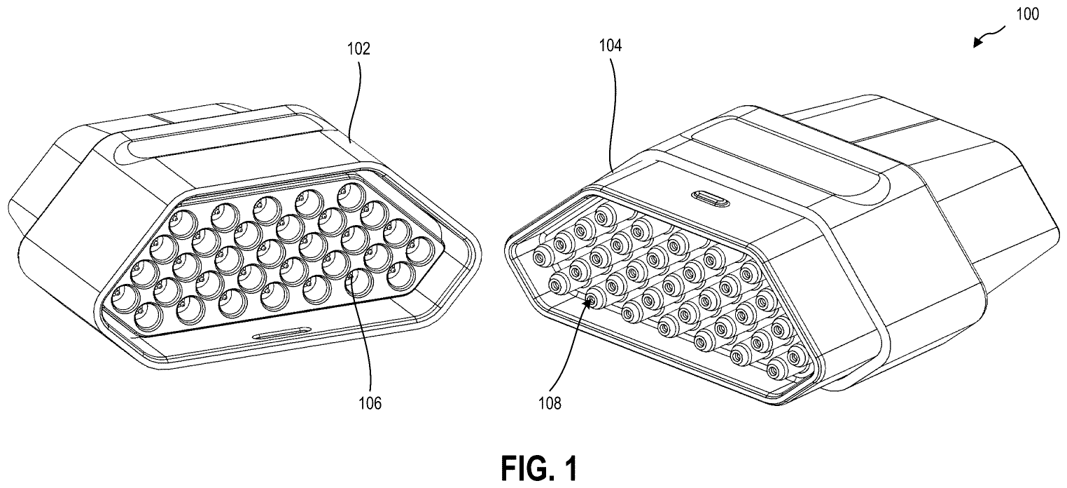

FIG. 1 is a perspective view of an embodiment of an electrical connection system 100 including a first electrical connector 102 and a second electrical connector 104. The first electrical connector 102 and second electrical connector 104 are configured to complementarily mate and provide an electrical connection therebetween. For example, the first electrical connector 102 may include a plurality of electrical contacts 106, and the second electrical connector 104 may include a plurality of electrical receptacles 108 configured to receive the plurality of electrical contacts 106. The physical contact between an electrical contact 106 and an electrical receptacle 108 allows an electric current to flow therebetween, provide electrical power across the electrical connection system 100.

In some embodiments, the voltage of the electrical power transmitted across the electrical connection system 100 is greater than 2 kilovolts (kV). In some embodiments, the voltage of the electrical power transmitted across the electrical connection system 100 is greater than 5 kV. In some embodiments, the voltage of the electrical power transmitted across the electrical connection system 100 is greater than 10 kV. In some embodiments, the voltage of the electrical power transmitted across the electrical connection system 100 is greater than 15 kV. In some embodiments, the voltage of the electrical power transmitted across the electrical connection system 100 is greater than 20 kV. In some embodiments, the voltage of the electrical power transmitted across the electrical connection system 100 is less than 50 kV. In some embodiments, the voltage of the electrical power transmitted across the electrical connection system 100 is between 2 kV and 50 kV. In some embodiments, the voltage of the electrical power transmitted across the electrical connection system 100 is between 5 kV and 40 kV. In some embodiments, the voltage of the electrical power transmitted across the electrical connection system 100 is between 10 kV and 35 kV. In some embodiments, an electrical voltage that exceeds a voltage creep path between two electrical connectors 106 or electrical receptacles 108 of the same electrical connector can cause the electrical connector to short and the electricity to arc between the two electrical contacts 106 or electrical receptacles 108. Arcing may damage the system, the connectors, other devices, and structures and injure operators.

In some embodiments, electrical connectors and/or an electrical connection system according to the present disclosure have a creep path with a breakdown voltage greater than the voltage of the electrical power transmitted across the electrical connection system 100. For example, in an electrical connection system 100 configured to transmit 10 kV, the electrical connection system 100 has a minimum creep path voltage between electrical contacts 106 and electrical receptacles 108 of no less than 10 kV. In another example, in an electrical connection system 100 configured to transmit 15 kV, the electrical connection system 100 has a minimum creep path voltage between electrical contacts 106 and electrical receptacles 108 of no less than 15 kV. In another example, in an electrical connection system 100 configured to transmit 20 kV, the electrical connection system 100 has a minimum creep path voltage between electrical contacts 106 and electrical receptacles 108 of no less than 20 kV.

In some embodiments, the contacts 106 and receptacles 108 are arranged in a hexagonal (e.g., honeycomb) arrangement. Such a hexagonal close-pack arrangement allows for a dense distribution of contacts 106 and/or receptacles 108. In such embodiments, each adjacent contact 106 and/or adjacent receptacle 108 is equidistant to each other adjacent contact 106 and/or receptacle 108. In some embodiments, the contacts 106 and receptacles 108 are arranged in other configurations, such as a circular pattern and/or concentric circles.

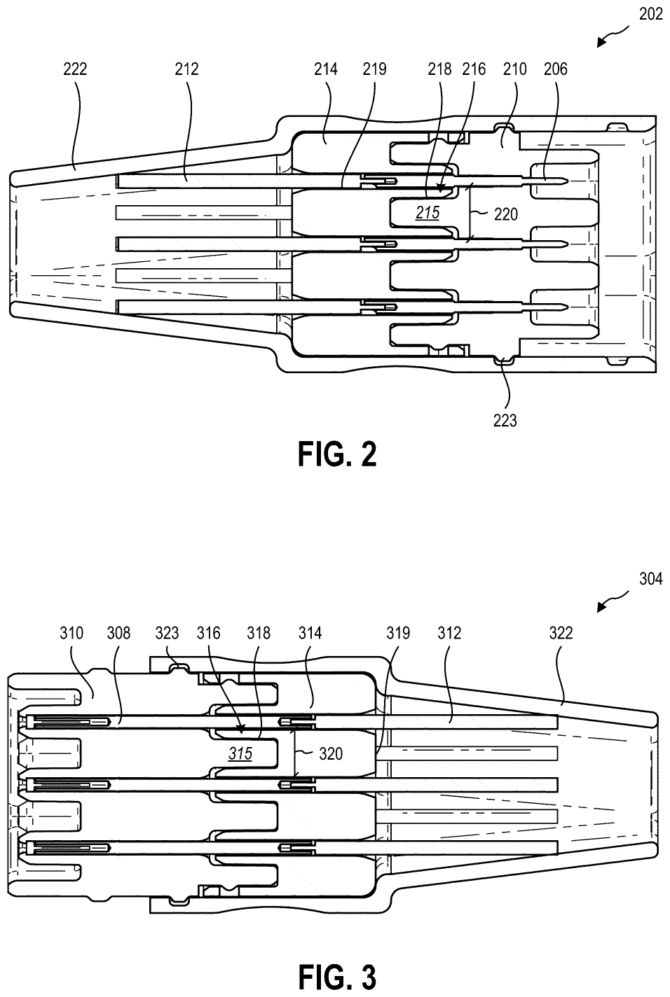

FIG. 2 is a side cross-sectional view of an embodiment of a first electrical connector 202. In some embodiments, the first electrical connector 202 includes a plurality of forward contacts 206 that are coupled to a front body 210. The forward contacts 206 are in electrical communication with a feed wire 212 that supplies electrical power to the forward contact 206. The feed wire 212 is supported by and/or positioned in a rear body 214. In some embodiments, the feed wire 212 is soldered to the forward contact 206. In some embodiments, the feed wire 212 is coupled to the forward contact 206 by another connection mechanism, such as a mechanical fastener or coupling, such as a clip or crimping the contact and wire together. In some embodiments, the feed wire 212 is coupled to the forward contact 206 by a conductive adhesive. In some embodiments, the feed wire 212 is coupled to the forward contact 206 by adhesive. In some embodiments, the feed wire 212 is connected to the forward contact 206 by an intermediate medium, such as another wire or a jumper connector.

The rear body 214 and the front body 210 form a dielectric barrier 216 between the rear body 214 and the front body 210 that creates a forward voltage creep path 218 with a breakdown voltage no less than the voltage of the electrical power communicated by the forward contacts 206. In some embodiments, the dielectric barrier 216 includes air in the voltage creep path 218 through which the voltage must pass. In some embodiments, the dielectric barrier 216 includes a gel.

In some embodiments, the dielectric barrier 216 includes a liquid. In some embodiments, the dielectric barrier 216 includes a suspension. In some embodiments, the dielectric barrier 216 includes a cured composition, such as an epoxy or hot melt polymer composition.

The front body 210 includes a plurality of protrusions 215 from the front body 210 that create a convoluted dielectric barrier 216 with a creep path length between the exposed portions of the forward contacts 206 that is greater than a direct distance 220 between the forward contacts 206. In some embodiments, the direct distance 220 is the shortest distance between two adjacent forward contacts 206. The creep path length between the two adjacent forward contacts 206 and the direct distance 220 defines a creep path ratio.

In some embodiments, the creep path ratio is no less than 2:1. For example, the creep path length is no less than 2 times longer than the direct distance 220. For example, the direct distance 220 may be approximately 6 mm and the creep path length may be approximately 12 mm. In some embodiments, the creep path ratio is no less than 4:1. For example, the creep path length is no less than 4 times longer than the direct distance 220. For example, the direct distance 220 may be approximately 6 mm and the creep path length may be approximately 30 mm. In some embodiments, the creep path ratio is no less than 6:1. In some embodiments, the creep path ratio is no less than 8:1. In some embodiments, a longitudinal length of the protrusion 215 is no less than 4 mm. In some embodiments, a longitudinal length of the protrusion 215 is no less than 6 mm. In some embodiments, a longitudinal length of the protrusion 215 is no less than 8 mm. A highly extended creep path, in some examples, may exhibit no benefit as the direct distance becomes increasingly small relative to the creep path length. In some embodiments, the creep path ratio is no more than 12:1. In some embodiments, the creep path ratio is no more than 10:1. In some embodiments, the creep path ratio is no more than 8:1. In some embodiments, the creep path ratio is in a range having any upper value described herein, any lower value described herein, any upper and lower value described herein, or any upper or lower values therebetween.

In some embodiments, the front body 210 and/or rear body 214 includes a polyethylene polymer with a breakdown voltage by distance that is greater than the dielectric barrier (e.g., air) along the creep path. In some embodiments, the creep path ratio is based at least partially on a creep breakdown voltage of the voltage creep path being greater than the direct breakdown voltage across the polymer or other material of the front body 210 and rear body 214.

For example, the polymer material may have a breakdown voltage of approximately 400 V/mm, while air has a breakdown voltage of up to approximately 75 V/mm, which is 5.33 times less than the polymer breakdown voltage. In practice, air may have a breakdown voltage as low as a range of 25-35 V/mm. The breakdown voltages define a breakdown voltage ratio. In the above example with a breakdown voltage ratio of 5.33, the total voltage needed to arc, therefore, would be approximately equal when the voltage creep path is 5.33 times as long as the direct distance 220 through the polymer material of the front body 210 and rear body 214. By convoluting the dielectric barrier and voltage creep path 218, the voltage creep path 218 can be extended to a length based at least partially on the breakdown voltage ratio. In some embodiments, the dielectric creep path ratio is selected to preferentially produce arcing across the polymer body.

In some embodiments, the first electrical connector 202 includes a rear creep path 219 behind the rear body 214 relative to the forward contacts 206. For example, the voltage carried between adjacent forward contacts 206 can cause a breakdown of the air or other material between the forward contacts 206. In some examples, the rear creep path 219 is an electrical breakdown path between the rearward portion of the forward contacts 206 (e.g., when the forward contacts 206 couple to the feed wires 212) and around the rear surface of the rear body 214. In some embodiments, the rear creep path has an additional material, such as epoxy, positioned against the rear body 214 to retain the feed wires 212 relative to the rear body 214. In some embodiments, an additional material, such as epoxy, positioned against the rear body 214 has a higher breakdown voltage than air.

As described herein, in some embodiments, the creep path ratio of the rear creep path 219 relative to the direct distance 220 is no less than 2:1. For example, the creep path length is no less than 2 times longer than the direct distance 220. In some embodiments, the creep path ratio of the rear creep path 219 relative to the direct distance 220 is no less than 4:1. In some embodiments, the creep path ratio is no less than 6:1. In some embodiments, the creep path ratio is no less than 8:1. A highly extended rear creep path 219, in some examples, may exhibit no benefit as the direct distance 220 becomes increasingly small relative to the creep path length. In some embodiments, the creep path ratio is no more than 12:1. In some embodiments, the creep path ratio is no more than 10:1. In some embodiments, the creep path ratio is no more than 8:1. In some embodiments, the creep path ratio is in a range having any upper value described herein, any lower value described herein, any upper and lower value described herein, or any upper or lower values therebetween.

In some embodiments, the first electrical connector 202 includes a cover 222 positioned around the front body 210 and rear body 214 in a lateral direction that is perpendicular to the longitudinal direction of the first electrical connector 202. In some embodiments, the cover 222 is fixed relative to the front body 210 in the longitudinal direction by a friction fit. In some embodiments, the cover 222 is fixed relative to the front body 210 in the longitudinal direction by a clip fit. For example, complementarily clips 223 in a laterally exterior side of the front body 210 and in the laterally interior side of the cover 222 may engage with one another to limit and/or prevent movement of the cover 222 in the longitudinal direction. In some embodiments, the cover 222 is fixed relative to the front body 210 in the longitudinal direction by a mechanical fastener. In some embodiments, the cover 222 is fixed relative to the front body 210 in the longitudinal direction by an adhesive or by over-molding of the cover 222.

The cover 222 further contacts the rear body 214. In some embodiments, the cover 222 includes a flange that contacts a rearward surface of the rear body 214 to limit and/or prevent longitudinal movement of the rear body 214 relative to the cover 222. In embodiments in which the cover 222 is longitudinally fixed relative to the front body 210, the cover 222 may limit and/or prevent longitudinal movement of the rear body 214 relative to the front body 210.

FIG. 3 is a side cross-sectional view of an embodiment of a second electrical connector 304. In some embodiments, the second electrical connector 304 includes a plurality of forward receptacles 308 that are coupled to a front body 310. The forward receptacles 308 are in electrical communication with a feed wire 312 that communicates electrical power to/from the forward receptacle 308. The feed wire 312 is supported by and/or positioned in a rear body 314. In some embodiments, the feed wire 312 is soldered to the forward receptacle 308. In some embodiments, the feed wire 312 is coupled to the forward receptacle 308 another connection mechanism, such as a mechanical fastener. In some embodiments, the feed wire 312 is coupled to the forward receptacle 308 by a conductive adhesive. In some embodiments, the feed wire 312 is coupled to the forward receptacle 308 by adhesive. In some embodiments, the feed wire 312 is connected to the forward receptacle 308 by an intermediate medium, such as another wire or a jumper connector.

The rear body 314 and the front body 310 form a dielectric barrier 316 between the rear body 314 and the front body 310 that creates a forward voltage creep path 318 with a breakdown voltage no less than the voltage of the electrical power communicated by the forward receptacle 308. In some embodiments, the dielectric barrier 316 includes air in the voltage creep path 318 through which the voltage must pass. In some embodiments, the dielectric barrier 316 includes a gel. In some embodiments, the dielectric barrier 316 includes a liquid. In some embodiments, the dielectric barrier 316 includes a suspension.

The front body 310 includes a plurality of protrusions 315 in the front body 310 that create a convoluted dielectric barrier 316 with a creep path length between the exposed portions of the forward receptacles 308 that is greater than a direct distance 320 between the forward receptacles 308. In some embodiments, the direct distance 320 is the shortest distance between two adjacent forward receptacles 308. The creep path length between the two adjacent forward receptacles 308 and the direct distance 320 defines a creep path ratio.

In some embodiments, the creep path ratio is no less than 2:1. For example, the creep path length is no less than 2 times longer than the direct distance 220. For example, the direct distance 220 may be approximately 6 mm and the creep path length may be approximately 12 mm. In some embodiments, the creep path ratio is no less than 4:1 For example, the creep path length is no less than 4 times longer than the direct distance 320. For example, the direct distance 320 may be approximately 6 mm and the creep path length may be approximately 30 mm. In some embodiments, the creep path ratio is no less than 6:1. In some embodiments, the creep path ratio is no less than 8:1.

In some embodiments, the front body 310 and/or rear body 314 includes a polymer with a breakdown voltage by distance that is greater than the dielectric barrier (e.g., air) along the creep path. In some embodiments, the creep path ratio is based at least partially on a creep breakdown voltage of the voltage creep path being greater than the direct breakdown voltage across the polymer or other material of the front body 310 and rear body 314.

For example, the polymer material may have a breakdown voltage of approximately 400 V/mm, while air has a breakdown voltage of approximately 75 V/mm, which is 5.33 times less than the polymer breakdown voltage. The breakdown voltages define a breakdown voltage ratio. In the above example with a breakdown voltage ratio of 5.33, the total voltage needed to arc, therefore, would be approximately equal when the voltage creep path is 5.33 times as long as the direct distance 320 through the polymer material of the front body 310 and rear body 314. By convoluting the dielectric barrier and voltage creep path 318, the voltage creep path 318 can be extended to a length based at least partially on the breakdown voltage ratio. In some embodiments, the dielectric creep path ratio is selected to preferentially produce arcing across the polymer body.

In some embodiments, the first electrical connector 302 includes a rear creep path 319 behind the rear body 314 relative to the forward receptacles 308. For example, the voltage carried between adjacent forward receptacles 308 can cause a breakdown of the air other material between the forward receptacles 308 proximate to the coupling with the feed wires 312. In some embodiments, the rear creep path has an additional material, such as epoxy, positioned against the rear body 314 to retain the feed wires 312 relative to the rear body 314. In some embodiments, an additional material, such as epoxy, positioned against the rear body 314 has a higher breakdown voltage than air.

As described herein, in some embodiments, the creep path ratio of the rear creep path 319 relative to the direct distance 320 is no less than 4:1. For example, the creep path length is no less than 4 times longer than the direct distance 320. For example, the direct distance 320 may be approximately 6 mm and the creep path length may be approximately 30 mm. In some embodiments, the creep path ratio is no less than 6:1. In some embodiments, the creep path ratio is no less than 8:1.

In some embodiments, the second electrical connector 304 includes a cover 322 positioned around the front body 310 and rear body 314 in a lateral direction that is perpendicular to the longitudinal direction of the first electrical connector 302. In some embodiments, the cover 322 is fixed relative to the front body 310 in the longitudinal direction by a friction fit. In some embodiments, the cover 322 is fixed relative to the front body 310 in the longitudinal direction by a clip fit. For example, complementarily clips 323 in a laterally exterior side of the front body 310 and in the laterally interior side of the cover 322 may engage with one another to limit and/or prevent movement of the cover 322 in the longitudinal direction. In some embodiments, the cover 322 is fixed relative to the front body 310 in the longitudinal direction by a mechanical fastener. In some embodiments, the cover 322 is fixed relative to the front body 310 in the longitudinal direction by an adhesive.

The cover 322 further contacts the rear body 314. In some embodiments, the cover 322 includes a flange that contacts a rearward surface of the rear body 314 to limit and/or prevent longitudinal movement of the rear body 314 relative to the cover 322. In embodiments in which the cover 322 is longitudinally fixed relative to the front body 310, the cover 322 may limit and/or prevent longitudinal movement of the rear body 314 relative to the front body 310.

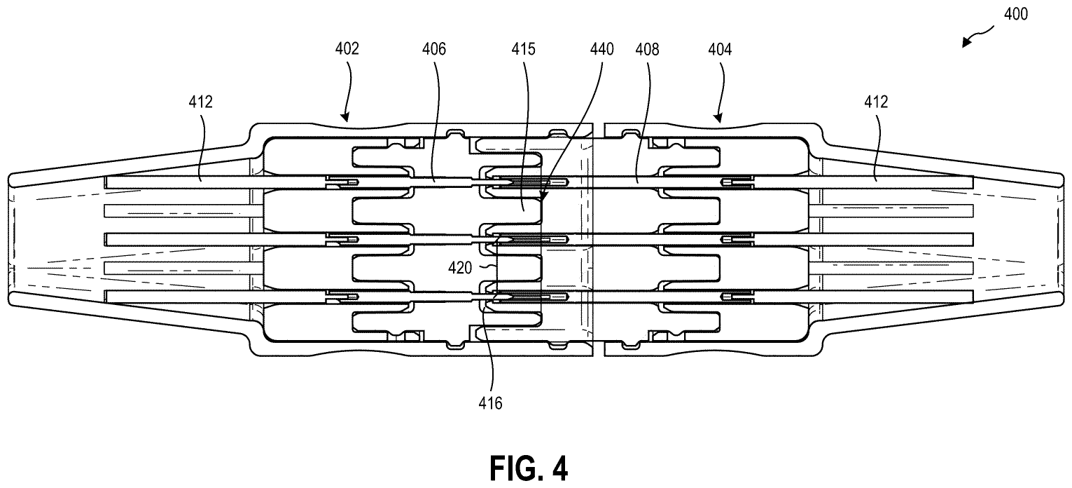

In some embodiments, any embodiment of a first electrical connector 202 described in relation to FIG. 2 and any embodiment of a second electrical connector 304 described in relation to FIG. 3 may be connectable in an embodiment of the electrical connection system 100 described in relation to FIG. 1. For example, FIG. 4 is a side cross-sectional view of a system of a first electrical connector 402 mated to a second electrical connector 404. The first electrical connector 402 includes a plurality of protrusions 415 that complementarily mate with the recesses 440 of the second electrical connector 404.

In some embodiments, the plurality of protrusions 415 and the plurality of recesses 440 form a connection dielectric barrier 416. In most instances, the electrical power transfers between the contacts 406 of the first electrical connector 402 to the receptacles 408 of the second electrical connector 404. In the event of damage to the feed wires 412 of one or both of the electrical connectors 402, 404 the electrical power may follow a voltage creep path between the contacts 406 of the first electrical connector 402 and/or between the receptacles 408 of the second electrical connector 404. The connection dielectric barrier limits and/or prevents arcing between forward contacts 406 and/or between the receptacles 408 in the case of damage to the feed wire(s) 412.

In some embodiments, the connection dielectric barrier 416 has creep path ratio no less than 4:1. For example, the creep path length is no less than 4 times longer than the direct distance 420 between the forward contacts 406. For example, the direct distance 420 may be approximately 6 mm and the creep path length may be approximately 30 mm. In some embodiments, the creep path ratio is no less than 6:1. In some embodiments, the creep path ratio is no less than 8:1.

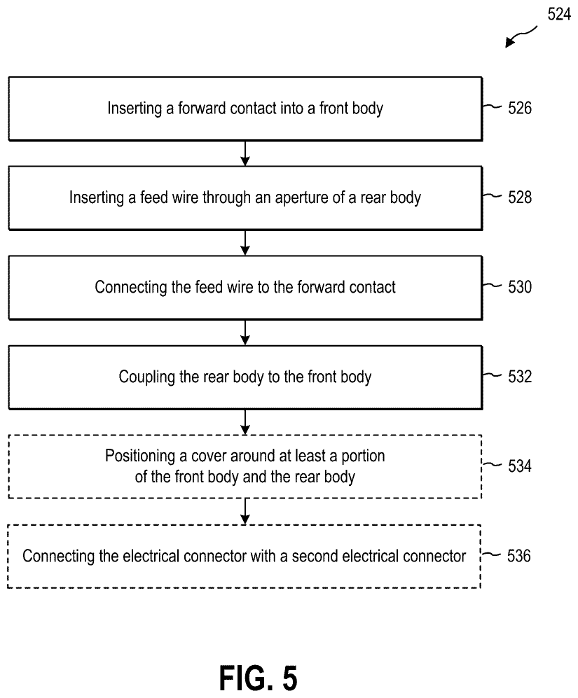

Electrical connectors, according to at least some embodiments of the present disclosure, simplify assembly while increasing the performance of the electrical connection system 400 relative to convention connectors. For example, conventional connectors secure the wires by potting with epoxy. FIG. 5 is a flowchart illustrating an embodiment of a method 524 of manufacturing electrical connectors and connection systems according to the present disclosure.

In some embodiments, the method 524 includes inserting a forward contact into the front body at 526. In some embodiments, inserting the forward contacts includes coupling the forward contacts to the front body. For example, coupling the forward contacts to the front body may include fixing the forward contacts to the front body via barbs protruding from the forward contacts that engage with the front body to limit and/or prevent removal of the forward contacts. For example, coupling the forward contacts to the front body may include fixing the forward contacts to the front body via adhesive to limit and/or prevent removal of the forward contacts.

The method 524 further includes inserting a feed wire through an aperture of the rear body at 528. The feed wire is inserted through the rear body without coupling the rear body to the feed wire. The feed wire and the rear body are free to move in the axial direction of the feed wire. In particular, the rear body is free to slide along the feed wire toward the front body. In at least one embodiment, the feed wire and/or aperture of the rear body includes a directional barb or other surface feature that resists and/or limits axial movement of the rear body relative to the feed wire in a first direction while allowing axial movement of the rear body relative to the feed wire in a second direction. For example, the directional barb allows the rear body to move axially toward the front body.

The method 524 further includes connecting the feed wire to the forward contact at 530. In some embodiments, connecting the feed wire to the forward contact includes crimping the forward contact to the feed wire. In some embodiments, connecting the feed wire to the forward contact includes soldering the feed wire to the forward contact. In some embodiments, connecting the feed wire to the forward contact include positioning an adhesive (e.g., a conductive adhesive) therebetween.

The method 524 further includes coupling the rear body to the front body at 532. In some embodiments, coupling the rear body to the front body includes moving the rear body axially along the feed wire toward the front body. In some embodiments, the front body and rear body couple to one another through a friction fit. In some embodiments, the front body connects to the rear body through a clip fit. In some embodiments, the front body connects to the rear body via a separate mechanical fastener. In some embodiments, the front body connects to the rear body via an adhesive.

In some embodiments, the method 524 further includes, optionally, positioning a cover around at least a portion of the front body and the rear body at 534. In some embodiments, the cover is fixed relative to the front body in the longitudinal direction by a friction fit. In some embodiments, the cover is fixed relative to the front body in the longitudinal direction by a clip fit. For example, complementarily clips in a laterally exterior side of the front body and in the laterally interior side of the cover may engage with one another to limit and/or prevent movement of the cover in the longitudinal direction. In some embodiments, the cover is fixed relative to the front body in the longitudinal direction by a mechanical fastener. In some embodiments, the cover is fixed relative to the front body in the longitudinal direction by an adhesive.

The cover further contacts the rear body. In some embodiments, the cover includes a flange that contacts a rearward surface of the rear body to limit and/or prevent longitudinal movement of the rear body relative to the cover. In embodiments in which the cover is longitudinally fixed relative to the front body, the cover may limit and/or prevent longitudinal movement of the rear body relative to the front body.

Optionally, the method 524 includes connecting the electrical connector to a second electrical connector at 536. In some embodiments, the first electrical connector connects to the second electrical connector through a friction fit. In some embodiments, the first electrical connector connects to the second electrical connector through a clip fit. In some embodiments, the first electrical connector connects to the second electrical connector via a separate mechanical fastener.

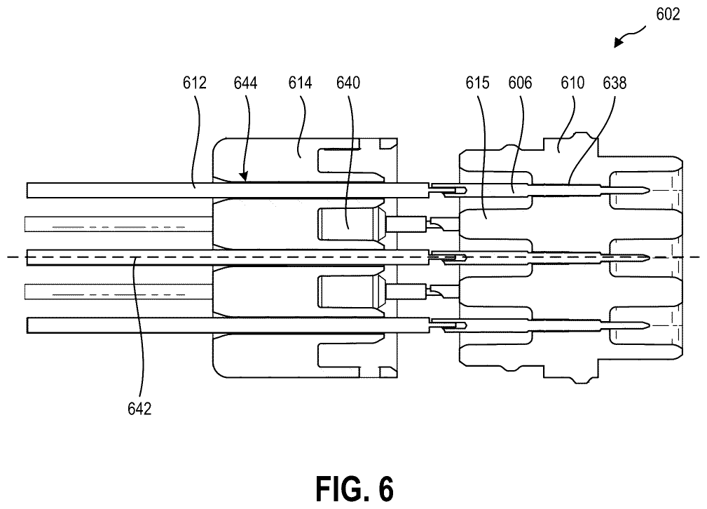

FIG. 6 illustrated an embodiment of a partially assembled electrical connector 602, such as according to the method described in relation to FIG. 5. In some embodiments, the electrical connector has a front body 610 and a rear body 614. A plurality of contacts 606 (or receptacles) are coupled to the front body 610, such as by barbs 638 that engage with the front body 610, to limit and/or prevent movement of the contacts 606 relative to the front body 610. Feed wires 612 are positioned through apertures 644 of the rear body 614, which allows the rear body to slide in a longitudinal direction 642 relative to the feed wires 612. The feed wires 612 are connected to the contacts 606 to provide electrical communication therebetween.

After the feed wires 612 are connected to the contacts 606, the rear body 614 is moved longitudinally along the feed wires 612 to mate with the front body 610. The protrusions 615 and recesses 640 define a convoluted dielectric barrier, as described herein, between the contacts 606. In some embodiments, the assembly process requires no epoxy or other material added to the rear surface of the rear body 614 to hold the feed wires 612, as the feed wires are connected to the contacts 606.

System and methods of providing electrical connections are described herein according to at least the following clauses:

Clause 1. An electrical connector comprising: a front body; a rear body; a first forward contact supported by the front body; a second forward contact supported by the front body a direct distance from the first forward contact; and a dielectric barrier between the first forward contact and second forward contact that defines a creep path that is no less than 2 times greater than the direct distance.

Clause 2. The electrical connector of clause 1, wherein the dielectric barrier includes air.

Clause 3. The electrical connector of clause 1 or 2, wherein the dielectric barrier includes complementarily mating protrusions and recesses on each of the front body and rear body.

Clause 4. The electrical connector of clause 3, wherein at least one protrusion of the complementarily mating protrusions and recesses has a longitudinal length of no less than 4 mm.

Clause 5. The electrical connector of any preceding clause, wherein the creep path is between the front body and rear body.

Clause 6. The electrical connector of any preceding clause, wherein the creep path is rear of the rear body relative to the front body.

Clause 7. The electrical connector of any preceding clause, wherein the creep path includes a forward creep path and a rear creep path, and the forward creep path and rear creep path are equal in length.

Clause 8. The electrical connector of any preceding clause, further comprising epoxy contacting a rear surface of the rear body relative to the front body.

Clause 9. The electrical connector of any preceding clause, further comprising a clip connection between the front body and the rear body configured to limit movement of the front body relative to the rear body.

Clause 10. The electrical connector of any preceding clause, wherein the first forward contact and the second forward contact are part of a plurality of forward contacts, and the plurality for forward contacts are arranged in a hexagonal distribution.

Clause 11. The electrical connector of any preceding clause, further comprising a first wire coupled to the first forward contact and a second wire coupled to the second forward contact.

Clause 12. The electrical connector of any preceding clause, wherein the first forward contact is couple to the front body via at least one lateral barb.

Clause 13. An electrical connection system, the system comprising: a first electrical connector; and a second electrical connectors, wherein a connection dielectric barrier between the first electrical connector and defines a connection creep path that is no less than 4 times greater than a direct distance between contacts of the first electrical connector or the second electrical connector.

Clause 14. The electrical connection system of clause 13, wherein the first electrical connector has a dielectric barrier between a first forward contact and a second forward contact that defines a forward creep path that is no less than 2 times greater than a direct distance between the first forward contact and the second forward contact.

Clause 15. The electrical connection system of clause 13 or 14, wherein the second electrical connector has a dielectric barrier between a first receptacle and a second receptacle that defines a forward creep path that is no less than 2 times greater than a direct distance between the first receptacle and the second receptacle.

Clause 16. A method of manufacturing an electrical connector, the method comprising: inserting a forward contact into a front body; inserting a feed wire through an aperture of a rear body; connecting the feed wire to the forward contact; and coupling the rear body to the front body.

Clause 17. The method of clause 16, wherein coupling the rear body to the front body includes sliding the rear body axially relative to the feed wire.

Clause 18. The method of any of clauses 16-17, wherein inserting a forward contact includes fixing the forward contact in the front body via barbs.

Clause 19. The method of any of clauses 16-18, wherein coupling the rear body to the front body includes fixing a cover to the front body.

Clause 20. The method of any of clauses 16-19, further comprising potting the feed wire in the rear body.

While particular embodiments have been chosen to illustrate the disclosed concepts, it will be understood by those skilled in the art that various changes and modifications can be made therein without departing from the scope of the disclosure as defined in the appended claims. It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

As used in this specification and the appended claims, the singular forms “a,” “an” and “the” include plural referents, unless the context clearly dictates otherwise. Similarly, the adjective “another,” when used to introduce an element, is intended to mean one or more elements. The terms “comprising,” “including,” “having” and similar terms are intended to be inclusive such that there may be additional elements other than the listed elements.

Additionally, where a method described above or a method claim below does not explicitly require an order to be followed by its steps or an order is otherwise not required based on the description or claim language, it is not intended that any particular order be inferred. Likewise, where a method claim below does not explicitly recite a step mentioned in the description above, it should not be assumed that the step is required by the claim.

It is noted that the description and claims may use geometric or relational terms, such as right, left, above, below, upper, lower, top, bottom, linear, arcuate, elongated, parallel, perpendicular, etc. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but still be considered to be perpendicular or parallel.

What is claimed is:

1. An electrical connector comprising:
a front body;
a rear body;
a first forward contact supported by the front body;
a second forward contact supported by the front body a direct distance from the first forward contact; and
a dielectric barrier between the first forward contact and second forward contact that defines a creep path that is no less than 2 times greater than the direct distance.

2. The electrical connector of claim 1, wherein the dielectric barrier includes air.

3. The electrical connector of claim 1, wherein the dielectric barrier includes complementarily mating protrusions and recesses on each of the front body and rear body.

4. The electrical connector of claim 3, wherein at least one protrusion of the complementarily mating protrusions and recesses has a longitudinal length of no less than 4 mm.

5. The electrical connector of claim 1, wherein the creep path is between the front body and rear body.

6. The electrical connector of claim 1, wherein the creep path is rear of the rear body relative to the front body.

7. The electrical connector of claim 1, wherein the creep path includes a forward creep path and a rear creep path, and the forward creep path and rear creep path are equal in length.

8. The electrical connector of claim 1, further comprising epoxy contacting a rear surface of the rear body relative to the front body.

9. The electrical connector of claim 1, further comprising a clip connection between the front body and the rear body configured to limit movement of the front body relative to the rear body.

10. The electrical connector of claim 1, wherein the first forward contact and the second forward contact are part of a plurality of forward contacts, and the plurality for forward contacts are arranged in a hexagonal distribution.

11. The electrical connector of claim 1, further comprising a first wire coupled to the first forward contact and a second wire coupled to the second forward contact.

12. The electrical connector of claim 1, wherein the first forward contact is couple to the front body via at least one lateral barb.

13. An electrical connection system, the system comprising:
a first electrical connector; and
a second electrical connectors, wherein a connection dielectric barrier between the first electrical connector and defines a connection creep path that is no less than 4 times greater than a direct distance between contacts of the first electrical connector or the second electrical connector.

14. The electrical connection system of claim 13, wherein the first electrical connector has a dielectric barrier between a first forward contact and a second forward contact that defines a forward creep path that is no less than 2 times greater than a direct distance between the first forward contact and the second forward contact.

15. The electrical connection system of claim 13, wherein the second electrical connector has a dielectric barrier between a first receptacle and a second receptacle that defines a forward creep path that is no less than 2 times greater than a direct distance between the first receptacle and the second receptacle.

16. A method of manufacturing an electrical connector, the method comprising:
inserting a forward contact into a front body;
inserting a feed wire through an aperture of a rear body;
connecting the feed wire to the forward contact; and
coupling the rear body to the front body.

17. The method of claim 16, wherein coupling the rear body to the front body includes sliding the rear body axially relative to the feed wire.

18. The method of claim 16, wherein inserting a forward contact includes fixing the forward contact in the front body via barbs.

19. The method of claim 16, wherein coupling the rear body to the front body includes fixing a cover to the front body.

20. The method of claim 16, further comprising potting the feed wire in the rear body.
